(19) United States
(12) Patent Application Publication
(10) Pub. No.: US 2017/0126612 A1
(43) Pub. Date: May 4, 2017

(54) Socially Accepted

(71) Applicant: Ryan Masti, Cameron, NY (US)

(72) Inventor: Ryan Masti, Cameron, NY (US)

(21) Appl. No.: 14/927,818

(22) Filed: Oct. 30, 2015

(51) Int. Cl. H04L 12/58; H04L 29/08

(52) U.S. Cl. CPC H04L 51/32; H04L 67/306; H04L 51/10

(57) ABSTRACT

The disclosed invention is a computer network based communicating service system to facilitate communication between disabled users. The system is comprised of a central server connected to a network providing a social computing based means to facilitate communication between disabled users. It is connected to a plurality of client computer terminals through said network, each of the plurality of client computer terminals adapted to receive and transmit messages over the network. Furthermore, a method is provided to facilitate web-based communication between disabled users on a computer network comprised of a central server that is connected to a network and a plurality of client computer terminals through the network. Each of the plurality of client computer terminals adapted to receive and transmit messages over the network.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

This invention generally relates to social networking systems, particularly systems and methods for assisting those with disabilities.

(2) Background

Social networking systems allow users to connect to and communicate with other users of the social networking system. Users create profiles on the social networking system that are tied to their identities and include information about the users, such as interests and demographic information. Because of the increasing popularity of social networking systems and the significant amount of user-specific information maintained by social networking systems, a social networking system presents an ideal forum for users to share their interests and experiences with other users. For example, a social networking system allows its users to upload content, exchange information, organize events, post content for presentation to other users, and communicate messages to each other.

With a growing population, the number of developmentally disabled children grows. Additionally, the rates at which children have been diagnosed as developmentally disabled, particularly with autism spectrum disorders (ASD), have steadily increased. Individuals with developmental disabilities often have several challenges in common, including but not limited to speech and language impairments, cognitive deficits, social problems, behavioral problems, memory problems, attention deficits, and sensory processing dysfunction. The developmentally disabled population extends beyond those with ASD to include those with Down syndrome, cerebral palsy, Fragile X syndrome, ADD/ADHD, cognitive challenges, and other disabilities. Moreover, various late-onset disorders and conditions often lead to similar challenges (e.g., Alzheimer's disease, Parkinson's disease, dementia, stroke, and brain injury). The manifestations of such disabilities can vary greatly from individual to individual (particularly in those with ASD, a disorder known for its “spectrum” of neurological impairments). As time goes by, parents, family members, friends, and therapists who spend time with disabled persons develop their own understanding of each disabled individual's unique set of challenges and faculties. Each caregiver may build his or her own set of tactics for managing challenges that confront the disabled individual, whether the challenges be health issues, emotional swings, or everyday adjustments to new environments and situations. As these circumstances arise in day-to-day life, the disabled person may greatly benefit from the assistance of specific caregivers that have grown to know and understand the disabled person.

Therefore, there exists a need to provide a social networking means for people with disabilities so that they have the opportunity to communicate, share and receive advice, or care about their condition.

### BRIEF SUMMARY OF THE INVENTION

Primarily, the invention is a computer networked based communicating service system to facilitate communication between disabled users. The system is comprised of a central server that is connected to a network providing a social computing based means to facilitate communication between disabled users. The invention is connected to a plurality of client computer terminals through said network, each of which is adapted to receive and transmit messages over the network.

Furthermore, a means is provided to enable a user to create a user account using the client computer terminals. To create the user account, the user provides personal information, such as name, date of birth, gender, city of residence and state or zip code, disability(ies), etc. Upon the creation of a user account, a user is provided with login credentials for the secure access to said user account. A user profile is generated as said user creates said user account. The user account enables said user to access a user profile corresponding to said user account on said social computing based means. Also, the invention provides a means for a user to post at least one information item over the social computing based network via the client computer terminals and another means for the user to view at least one news item posted by the other users via the client computer terminals

A preferred embodiment the invention is a method to facilitate a web-based communication between disabled users on a computer network. The network is comprised of a central server that is connected to a network and a plurality of client computer terminals through the network. Each of the plurality of client computer terminals is adapted to receive and transmit messages over said network. The method according to the invention are steps of providing, through a social computing based means, a means to enable a user to create a user account via the client computer terminals. The user account enables the user to access a user profile corresponding to said user account on the social computing based means, thereby providing, through the social computing based means, a means for a user to post at least one information item, such as a text and/or audio and/or video and/or picture and/or a combination of text, audio or video, over the social computing based network and providing, through the social computing based means, a means for the user to view at least one news item posted by other users.

Furthermore, the invention provides a means for a user to communicate with a user with similar disabilities. Also, the system enables a user to communicate with a user who can provide a disabled user with support services.

The summary is provided to introduce a selection of concepts, in a simplified form, that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description. The invention is capable of other embodiments, and of being practiced and carried out in various ways. Also, it is to be understood that the phraseology and terminology employed herein are for the purpose of description, and should not be regarded as limiting. These, together with other objectives of the invention and the various features of novelty that characterize the invention, are pointed out with particularity in the disclosure. For a better understanding of the invention, its operating advantages, and the specific objectives attained by its uses, reference should be had to the accompanying descriptive matter, in which there are illustrated preferred embodiments of the invention.

### DETAILED DESCRIPTIONS OF THE INVENTION

The following is a detailed description of example embodiments of the invention. The example embodiments are in such detail as to clearly communicate the invention. However, the amount of detail offered is not intended to limit the anticipated variations of the embodiments. On the contrary, the intention is to cover all modifications, equivalents, and alternatives that fall within the spirit and scope of the present invention. The detailed descriptions below are designed to make such embodiments obvious to a person of ordinary skill in the art.

The present invention can be implemented on any communication device that has hardware components that can perform wireless and wired communication, such as (but not limited to)—multi-purpose pocket computers, personal multimedia devices, etc.

The various devices on which the applications that implement the present invention run may use one or more processors with different instruction-sets, architectures, clock-speeds, etc., and memory that may include high speed random access memory or non-volatile memory, such as one or more magnetic disk storage devices, flash memory devices, and other kinds of solid state memory devices.

The various applications that can implement the present invention run on electronic devices that may use at least one physical user interface device that provide the means of control and navigation within the operating system. Applications that run on the devices include (but are not limited to) touch-pads, such as those described in (but not limited to)—(1) U.S. patent application No. Application number: Ser. No. 10/722,948 (“Touch pad for handheld device”, filed Nov. 25, 2003); (2) U.S. patent application No. Application number: Ser. No. 10/188,182 (“Touch pad for handheld device”, filed Mar. 21, 2006); (3) U.S. patent application No: Ser. No. 08/210,610 (“Computer system with touchpad support in operating system”, filed Mar. 18, 1994); (4) U.S. patent application Ser. No. 643,256 (“Movable touch pad with added functionality”, filed Ser. No. 10/643,256), touch screens, such as those described in(but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005 ; (5) U.S. patent application Ser. No. 11/038,590, “Mode-Based Graphical User Interfaces For Touch Sensitive Input Devices,” filed on Jan. 18, 2005 ;(6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheels, such as those described in U.S. patent application Ser. No. 11/549,619 “Method, device, and graphical user interface for dialing with a click wheel” filed on Oct. 13, 2006, keyboards, such as those mentioned in(but not limited to) U.S. patent application Ser. No. 07/711,760 (“Ergonomic keyboard input device” , filed on Jun. 6, 1991) , mouse, such as those described in (but not limited to) (1)Application number: Ser No. 09/167,314 (“Computer mouse with enhance control button (s)”,filed on Oct. 6, 1998); (2) Application number: Ser. No. 08/288,945 (“Roller mouse for implementing scrolling in windows applications”, filed on Aug. 10, 1994), and gesture recognition means, such as those described in(but not limited to) (1) European Patent application publication number: EP2482176 A2 (“Multi-input gesture control for a display screen”, filed on Nov. 4, 2011) and (2) U.S. Patent application with publication number 20120317511 A1 (“DISPLAY WITH BUILT IN 3D SENSING CAPABILITY AND GESTURE CONTROL OF TV”, filed on Aug. 21, 2012).

The display means used by these devices may use LCD (liquid crystal display) technology, LED (light Emitting Diode) technology, CRT (Cathode ray tube) technology, or LPD (light emitting polymer) technology, or any other display technologies. Various realizations of graphics display circuitry that implement a Graphics Processing Unit (GPU) are used to achieve video interface between the user and these electronic devices.

Connectivity of these devices with networks, such as the internet, an intranet and/or wireless network, such as cellular telephone network, a wired or wireless local area network (LAN) and/or metropolitan area network (MAN) and/or WAN (wide area network), and other wireless communication, is achieved by use of a plurality of communication standards, protocols, and other technologies, such as Bluetooth, Wireless Fidelity (Wi-Fi), and/or any other suitable communication protocol, including communication protocols not yet developed as of the filing date of this document.

The present invention maybe implemented on applications that run on a single or variety of operating system platforms, including but not limited to OS X, WINDOWS, UNIX, IOS, ANDROID, SYMBIAN, LINUX, or embedded operating systems, such as VxWorks.

The present invention may also be implemented to work with various web browsers, including but not limited to Internet Explorer, Mozilla Firefox, Safari, and

Opera, that access and handle various types of web pages constructed with various mark-up languages, such as HTML, HTML-5, XHTML, XML, etc., and the associated CSS (cascading style sheet) files and java-script files.

A computer networked based communicating service system is disclosed that enables people with disabilities, such as Autism, hearing impaired, intellectual disabilities, learning disabilities (ex. ADHD), physical disabilities, speech and language disorders, and mental illness, to communicate and interact.

The system will include the opportunity for people to log their own experiences, offer suggestions, or help those with a disability. The system uses information on a profile to connect them with others who suffer from a similar disability. Furthermore, the system monitors the search interest of a user to make an intelligent marker for history. Furthermore, after a user creates their profile, the user will be able to upload pictures, post updates about their most recent experiences, and connect with other users and certified professionals.

The invention is a computer networked based communicating service system to facilitate communication between disabled users. The system is comprised of a central server that is connected to a network that provides a social computing based means to facilitate communication between disabled users and is configured to be connected to a plurality of client computer terminals through said network. Each of the plurality of client computer terminals is adapted to receive and transmit messages over the network.

The invention is an information retrieval system that is comprised of a database containing information regarding a plurality of users with disabilities on a server that is configured to receive, retrieve and deliver information regarding disabled users from at least one client access device, such as a cellphone, smartphone, PDA, etc.

Furthermore, a means is provided to enable a user to create a user account using the client computer terminals. To create the user account, the user provides personal information, such as name, date of birth, gender, city of residence and state or zip code, disability(ies), etc. Upon the creation of a user account, a user is provided with login credentials for the secure access to said user account. A user profile is generated as said user creates said user account. The user account enables said user to access a user profile corresponding to said user account on said social computing based means. Also, the invention provides a means for a user to post at least one information item over the social computing based network via the client computer terminals and another means for the user to view at least one news item posted by the other users via the client computer terminals

A preferred embodiment of the invention is a method to facilitate a web-based communication between disabled users on a computer network. The network is comprised of a central server that is connected to a network and a plurality of client computer terminals through the network. Each of the plurality of client computer terminals is adapted to receive and transmit messages over said network. The method according to the invention are steps of providing, through a social computing based means, a means to enable a user to create a user account via the client computer terminals. The user account enables the user to access a user profile corresponding to said user account on the social computing based means, thereby providing, through the social computing based means, a means for a user to post at least one information item, such as a text and/or audio and/or video and/or picture and/or a combination of text, audio or video, over the social computing based network and providing, through the social computing based means, a means for the user to view at least one news item posted by other users.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed:

1. A computer networked based communicating service system to facilitate communication between disabled users, said system comprising:
a central server that is connected to a network that provides a social computing based means to facilitate communication between disabled users. It is connected to a plurality of client computer terminals through said network. Each of said plurality of client computer terminals is adapted to receive and transmit messages over said network;
a means to enable a user to create a user account via said client computer terminals, wherein said user account enables said user to access a user profile corresponding to said user account on said social computing based means;
a means to said user to post at least one information item over said social computing based network via said client computer terminals; and
a means to said user to view at least one news item posted by said other users via said client computer terminals.

2. The computer networked based communicating service system to facilitate communication between disabled users as set forth in claim 1, wherein said user profile is generated as said user creates said user account.

3. The computer networked based communicating service system to facilitate communication between disabled users as set forth in claim 1, wherein said user is provided with login credentials upon creating said user account for a secure access to said user account.

4. The computer networked based communicating service system to facilitate communication between disabled users as set forth in claim 1, wherein said user account is further comprised of the personal information of said user.

5. The computer networked based communicating service system to facilitate communication between disabled users as set forth in claim 1, wherein said information item is in textual format.

6. The computer networked based communicating service system to facilitate communication between disabled users as set forth in claim 1, wherein said information item is in audio format.

7. The computer networked based communicating service system to facilitate communication between disabled users as set forth in claim 1, wherein said information item is in video format.

8. The computer networked based communicating service system to facilitate communication between disabled users as set forth in claim 1, wherein said information item is a combination of text, audio or video.

9. The computer networked based communicating service system to facilitate communication between disabled users as set forth in claim 1, wherein said information item is a picture.

10. The computer networked based communicating service system to facilitate communication between disabled users as set forth in claim', wherein said central server is comprised of a curated database of user account.

11. A method to facilitate a web-based communication between disabled users on a computer network comprising a central server connected to a network and configured to be connected to a plurality of client computer terminals through said network, each of said plurality of client computer terminals adapted to receive and transmit messages over said network, said method comprising:
providing, through a social computing based means, a means to enable a user to create a user account via said client computer terminals, wherein said user account enables said user to access a user profile corresponding to said user account on said social computing based means.
providing, through said social computing based means, a means for said user to post at least one information item over said social computing based network; and
providing, through said social computing based means, a means for said user to view at least one news item posted by said other users.
